(19) United States
(12) Patent Application Publication
(10) Pub. No.: US 2018/0101599 A1
(43) Pub. Date: Apr. 12, 2018

(54) INTERACTIVE CONTEXT-BASED TEXT COMPLETIONS

(71) Applicant: Microsoft Technology Licensing, LLC, Redmond, WA (US)

(72) Inventors: Kenneth C. Arnold, Cambridge, MA (US); Kai-Wei Chang, Taipei (TW); Adam Tauman Kalai, Lexington, MA (US)

(73) Assignee: Microsoft Technology Licensing, LLC, Redmond, WA (US)

(21) Appl. No.: 15/289,171

(22) Filed: Oct. 8, 2016

(51) Int. Cl. G06F 17/30

(52) U.S. Cl. CPC G06F 17/30643; G06F 17/30696; G06F 17/30684

(57) ABSTRACT

An “Interactive Text Completion System” provides various techniques for presenting a user with personalized context-based multi-word text completion suggestions via a user interface. The multi-word text completion suggestions are updated in real-time as the user types and/or selects one or more words of the completion suggestions. The Interactive Text Completion System applies a language model in combination with a document context to generate the completion suggestions. In various implementations, the language model is generated from a store of prior documents created or edited by the user. As such, the language model is personalized to individual users based on prior documents of those users. However, any desired source or corpus of existing documents can be used to generate the language model. The resulting language model offers relatively long completion suggestions (e.g., phrases consisting of a sequence of multiple words) based on the current document context.

### BACKGROUND

A wide variety of applications have been implemented for autocompleting words or search queries. For example, one existing sentence completion scheme applies information retrieval techniques to find a suitable sentence completion in response to user entered text. However, this existing sentence completion scheme, and several related works, generally focus on completing sentences without considering document context. Other work has explored phrase prediction, where phrases need not necessarily end sentences.

Techniques such as N-gram based language models often rely on large document collections from large numbers of authors as training data. However, such language models often have difficulty generating grammatical and semantically proper sentences, especially on collections of text with high entropy. In contrast, neural language models have recently proven very effective in generating proper sentences. Further, several studies in natural language processing and information retrieval have been conducted for problems similar to sentence completion. Such techniques often focus on completing a sentence with a short phrase or completing queries to a search engine. A related email-based technique suggests several different short replies to entire email messages. In this case, the user simply selects one of the suggested automated replies in its entirety and then either sends that reply or manually edits the selected automated reply prior to sending that reply.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

In general, an “Interactive Text Completion System” as described herein, provides various techniques for presenting the user with personalized context-based multi-word text completion suggestions for use in creating and/or editing documents. Examples of documents that may be created and/or edited via the Interactive Text Completion System include, but are not limited to, email and text messages, product reviews, articles, personal letters, reports, requests, etc. Advantageously, the use of these multi-word text completion suggestions significantly reduces user workload and time spent in generating a wide variety of document types while possibly also improving the quality of those documents. In general, these multi-word text completion suggestions include, but are not limited to sentence endings, entire sentences, partial or full paragraphs, documents, sets of documents, etc., which are extracted from one or more preexisting source documents.

In various implementations, user selection of one or more words of any multi-word text completion suggestion is performed via a user interface that enables sequential selection of individual words or multi-word phrases or sentences of the multi-word text completion suggestion. For example, in various implementations user selection from the multi-word text completion suggestions is performed by successive selections of one or more selectable words of one or more of the multi-word text completion suggestions. More specifically, in various implementations, selection of any word within any multi-word text completion suggestion initiates a selection of the selected word and each preceding selectable word of that multi-word text completion suggestion.

Further, in various implementations, based on the current document context, multi-word text completion suggestions may be presented to the user before the user begins typing or otherwise entering a particular word into the document, thereby further reducing user workload. There is no explicit limit to the amount of content in the multi-word text completion suggestions. For example, the multi-word text completion suggestions can include multiple words, one or more multi-word phrases, entire sentences, one or more paragraphs, etc.

In various implementations, the multi-word text completion suggestions are a combination of both predicted word completions (e.g., the remainder of a word that a user has begun entering, a spelling corrected word, or a complete next word) and sequences of multiple suggested follow-on words. When generating the multi-word completion suggestions, a machine-learned retrieval model is first applied to extract a plurality of candidate suggestions from a corpus of pre-existing documents (also referred to herein as “source documents”) based on a current content of the current user document. These candidate suggestions are then scored by a language model based on an automatically determined document context, with a plurality of highest scoring candidate suggestions then being presented or otherwise output as the aforementioned multi-word completion suggestions.

Both the retrieval model and the language model are trained, via any of a variety of machine-learning techniques, on a corpus of preexisting documents. Advantageously, these models need not be trained on the same corpus of preexisting documents. Further, the preexisting documents on which one or both of these models are trained need not be the same as the preexisting documents to which these models are applied for generation of completion suggestions. This enables one or both of these models to be trained offline on large datasets and presented to end-user applications (either locally or via cloud-based services) to generate completion suggestions from the user's own document stores.

In general, the document context is a function of various features, including, but not limited to, previous documents (including document sentences and metadata), preceding sentences in the current document, and metadata of the current document. In general, the use of the term “previous documents” in terms of document context refers to either all previous documents (e.g., some or all of the documents used for training the language model), or to a subset of those previous documents that are determined to be relevant based on the document context (e.g., prior emails with the same recipient) and/or content of the current user document. In general, the metadata for both the previous and current documents includes, but is not limited to, document- or email-specific features including subject, date, recipients, etc., type of document, content of the document, specific details or content from prior messages or related documents, document title, whether the document is personal or work-related, etc. Further, the automatically determined document context may change over time as the document is being created. As such, in various implementations, the document context of the current document is periodically or continuously updated.

For example, in various implementations, the Interactive Text Completion System first applies a retrieval model to extract a plurality of multi-word candidate phrases from a corpus of preexisting documents based on a current content of a current user document. The Interactive Text Completion System then determines a document context of the current user document. Given the context and the candidate phrases, the Interactive Text Completion System then applies a language model, trained on the corpus of preexisting documents, to score each of the plurality of candidate phrases based on the document context. In various implementations, past user behavior (e.g., kinds of suggestions they accept) and user traits (personality, type of work, etc.) may also be used as weights to increase or decrease the computed scores. Finally, the Interactive Text Completion System outputs a plurality of highest scoring candidate phrases as multi-word text completion suggestions. As discussed in further detail herein, each of the multi-word text completion suggestions comprises a sequence of two or more words representing a verbatim text string extracted from the corpus of preexisting source documents.

Given these multi-word text completion suggestions, in various implementations, the Interactive Text Completion System then renders an interactive user interface on a display device. In various implementations, this user interface includes a text input region for creating and/or editing the current user document and one or more completion suggestion controls. In various implementations, each of these completion suggestion controls is applied to present a separate one of the multi-word text completion suggestions. In addition, in various implementations, the Interactive Text Completion System appends a sequence of words or phrases to the current user document via the text input region by successive selection of one or more words or sub-phrases from of the multi-word text completion suggestions via one or more corresponding completion suggestion controls. Further, in various implementations, particular user actions or inputs can result in the insertion of suggestion units of various size, e.g., a certain gesture or input mechanism may cause an entire suggested phrase to be inserted through the next punctuation mark of that suggested phrase.

The Interactive Text Completion System described herein provides various techniques for presenting personalized context-based multi-word text completion suggestions that are updated in real-time as the user types and/or selects one or more words of the multi-word text completion suggestions. In addition to the benefits described above, other advantages of the Interactive Text Completion System will become apparent from the detailed description that follows hereinafter.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for effecting various implementations an “Interactive Text Completion System”, as described herein

FIG. 2 illustrates an exemplary interactive user interface for the Interactive Text Completion System, as described herein.

FIG. 3 illustrates an exemplary interactive user interface for the Interactive Text Completion System, as described herein.

FIG. 4 illustrates an exemplary interactive user interface for the Interactive Text Completion System, as described herein.

FIG. 5 illustrates a general system flow diagram that illustrates exemplary techniques for effecting various implementations of the Interactive Text Completion System, as described herein.

FIG. 6 illustrates a general system flow diagram that illustrates exemplary techniques for effecting various implementations of the Interactive Text Completion System, as described herein.

FIG. 7 illustrates a general system flow diagram that illustrates exemplary techniques for effecting various implementations of the Interactive Text Completion System, as described herein.

FIG. 8 is a general system diagram depicting a simplified general-purpose computing device having simplified computing and I/O capabilities for use in effecting various implementations of the Interactive Text Completion System, as described herein.

### DETAILED DESCRIPTION

In the following description of various implementations of an “Interactive Text Completion System”, reference is made to the accompanying drawings, which form a part hereof, and in which is shown by way of illustration specific implementations in which the Interactive Text Completion System may be practiced. Other implementations may be utilized and structural changes may be made without departing from the scope thereof.

Specific terminology will be resorted to in describing the various implementations described herein, and that it is not intended for these implementations to be limited to the specific terms so chosen. Furthermore, it is to be understood that each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the Interactive Text Completion System. Further, the appearance of such phrases throughout the specification are not necessarily all referring to the same implementation, and separate or alternative implementations are not mutually exclusive of other implementations. The order described or illustrated herein for any process flows representing one or more implementations of the Interactive Text Completion System does not inherently indicate any requirement for the processes to be implemented in the order described or illustrated, and any such order described or illustrated herein for any process flows do not imply any limitations of the Interactive Text Completion System.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive in a manner similar to the term “comprising” as an open transition word without precluding any additional or other elements.

1.0 Introduction:

In general, the “Interactive Text Completion System” described herein provides various techniques for presenting user-selectable personalized context-based multi-word text completion suggestions. Further, the Interactive Text Completion System provides a variety of user interface implementations to enable users to rapidly interact with and make selections from the multi-word text completion suggestions. In general, these multi-word text completion suggestions include, but are not limited to sentence endings, entire sentences, partial or full paragraphs, documents, sets of documents, etc. that are extracted from among all phrases and all positions within those phrases in one or more sets of preexisting source documents. These completion suggestions are extracted as candidates from a corpus of existing documents (also referred to herein as previous or prior documents or source documents) by applying a retrieval model to that corpus and then applying a language model to score those candidates.

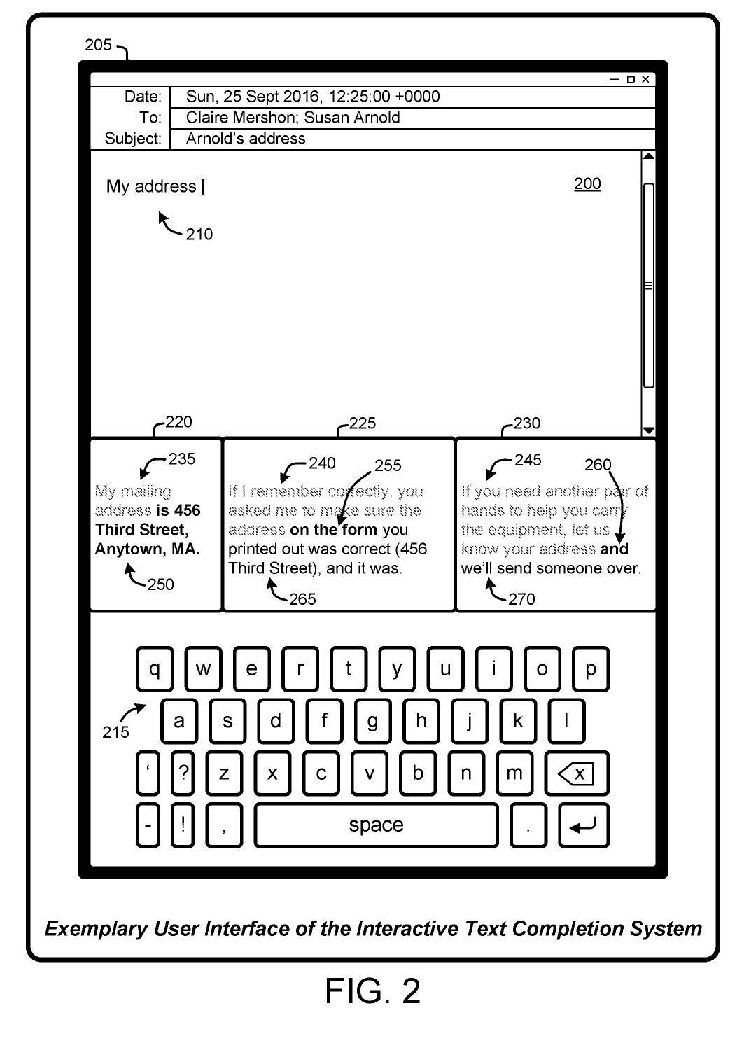

In general, each of the multi-word text completion suggestions comprises a sequence of two or more words representing a verbatim text string extracted from the corpus of preexisting documents. Further, because the text strings are verbatim extractions, in various implementations, one or more of the multi-word text completion suggestions may include non-selectable text that precedes the selectable text so as to show a larger portion of the original document from which that multi-word text completion suggestion was extracted. An example of this inclusion of non-selectable text preceding the multi-word text completion suggestions is illustrated in FIG. 2, described in further detail below.

The suggested “words” of the multi-word text completion suggestions include various combinations of actual words, slang words, punctuation (e.g., spaces, commas, periods, exclamation points, etc.), symbols, emoji's, etc. However, each of these different elements (e.g., words, slang, punctuation, etc.) will be jointly referred to herein as “words” for purposes of explanation and discussion. Various features of the Interactive Text Completion System are applicable to a wide variety of document creation and editing scenarios, including, but not limited to, accessibility, email and messaging, customer relations, technical support, foreign language learning, review writing (e.g., user-authored reviews of businesses, objects, places, services, etc.), collaborative work, etc.

In various implementations, one or more of the highest scoring candidates are presented to the user as the multi-word text completion suggestions. In other words, multiple different multi-word text completion suggestions may be concurrently provided or displayed to the user. The user may then select from any or all of these concurrent multi-word text completion suggestions. In various implementations, some or all of the concurrent multi-word text completion suggestions are updated in real-time as the user types and/or selects one or more words of the completion suggestions. In other words, the multi-word text completion suggestions provided by the Interactive Text Completion System may be dynamically updated in real-time in response to user inputs and selections, and in response to any changes in a current document content and context as that document evolves over time.

For example, in various implementations, user selection of one or more words of any multi-word text completion suggestion is performed via a user interface that enables sequential selection of individual words or multi-word phrases of the multi-word text completion suggestion. In various implementations user selection from the multi-word text completion suggestions is performed by successive selections of one or more selectable words of one or more of a plurality of multi-word text completion suggestions being concurrently displayed to the user. More specifically, in various implementations, selection of any word within any multi-word text completion suggestion initiates a combined selection of the user-selected word and each preceding selectable word of that multi-word text completion suggestion. However, given the wide variability of user interfaces that may be implemented, the Interactive Text Completion System is not intended to be limited to the exact details of the various user interface examples described herein.

In various implementations, the multi-word text completion suggestions include verbatim text segments (e.g., multiple sequential words) extracted from the user's prior documents (or other document store) by the aforementioned retrieval model based on the current document content and context. For example, if the user is typing an email, the Interactive Text Completion System can generate multiple suggestions of what to write next based on things that the user has previously written in similar contexts. In other words, the Interactive Text Completion System offers completion suggestions of natural language as a user types an email message or other document, based on the current document content and context and the user's own prior documents. In various implementations, the multi-word text completion suggestions include, but are not limited to, partial or full sentence completion suggestions, personalized salutations and signatures, complete documents, etc.

Consider the following simple example of a scenario in which multi-word text completion suggestions are generated and presented via the interactive user interface. Assume that a user is writing a separate form response to a set of multiple different recipients. In this example, the “document” being composed is actually a set of documents where specific details (such as the recipient's name or organization) will be filled in. In this case, as soon as the user has created one version of the document addressed to one recipient, the next version of that same document is automatically created in full, complete with details for the next recipient, by extracting some or all of the content for the next version of the document from the prior version created by the user. The user interface for such a scenario could be very similar to the mail merge type functionality available in various word processor applications. However, it is clear that this example is provided only for purposes of explanation and discussion and is not intended to limit the scope or functionality of the Interactive Text Completion System.

In general, the document context is a function of various features, including, but not limited to, previous documents (including document sentences and metadata), preceding sentences in the current document, and metadata of the current document. In general, the metadata, for both the previous and current documents may include, but is not limited to, document- or email-specific features including subject, date, recipients, etc., type of document, content of the document, specific details or content from prior messages or related documents, document title, whether the document is personal or work-related, etc.

For purposes of explanation and discussion, the following paragraphs focus on applying the Interactive Text Completion System to complete sentences via user selection of words from the multi-word text completion suggestions presented via an interactive user interface. However, the Interactive Text Completion System is fully capable of enabling the user to complete other blocks of text (e.g., sentence endings, entire sentences, partial or full paragraphs, documents, sets of documents, etc.) in a wide variety of documents. Such documents include, but are not limited to, email and text messages, product reviews, articles, personal letters, reports, requests, etc. In various implementations, the Interactive Text Completion System focuses on long completions and employs various document context features to predict one or more multi-word text completion suggestions.

As mentioned previously, the retrieval model is derived from a store of prior documents created or edited by the user (or any other desired source or corpus of existing documents). Similarly, the language model is also derived from a store of prior documents created or edited by the user (or any other desired source or corpus of existing documents). Both the retrieval model and the language model are trained, via any of a variety of machine-learning techniques, on a corpus of preexisting documents. For example, the either or both of these models may be trained on, for example, large email collections (or other documents) in a corporate email server.

Advantageously, different stores of prior documents may be used to train or otherwise generate either or both the retrieval model and the language model. In other words, these models need not be trained on the same corpus of preexisting documents. Further, the preexisting documents on which either or both of these models are trained need not be the same as the preexisting documents to which these models are subsequently applied for generation of completion suggestions. This enables one or both of these models to be trained offline on large datasets and presented to end-user applications (either locally or via cloud-based services) to generate completion suggestions from the user's own document stores (or any other document store). Further, source documents (for generation of multi-word text completion suggestions) other than those created by the user may be used to assist the user when generating documents in unfamiliar domains, foreign languages, etc.

Techniques applied to generate the retrieval model and the language model include, but are not limited to, statistical language models, contextual neural language models, recurrent neural networks, N-gram based language prediction models, etc. In various implementations, such training applies various privacy mechanisms, such as, for example, differential privacy, to ensure that the resulting model does not leak personal or confidential information. Further, the retrieval model and the language model may be trained via different machine-learning techniques. In addition, in various implementations, weights for training the language model may optionally be learned or adjusted via the use of a “retype process” as discussed in further detail in Section 2.2 of this document. The resulting retrieval model and language model may then be provided in the form of model parameters to the user's device. Similarly, the learned model parameters may be accessible to the Interactive Text Completion System via a cloud-based service or the like.

In general, the retrieval model identifies and extracts multi-word candidate phrases from “source documents” based on a current content (and optionally the current context) of a current user document. Advantageously, in various implementations, these candidates may be generated by the retrieval model based on the context (e.g., document recipients, document type, title, etc.) even when there is no content (e.g., a new blank document). The source documents from which the candidates are extracted may be the user's prior documents (or some context-based subset of those documents) or any other corpus of preexisting documents created by one or more authors.

The language model then applies the current document context to each of the extracted multi-word candidate phrases to score those candidates. In general, the scores assigned to candidate phrases by the language model indicate a likelihood of each candidate phrase being a sensible or acceptable thing to say in the context of the current document. More specifically, in various implementations, the scoring performed by the language model is based on a combination of various scoring elements that are used to compute the score of a candidate phrase. As mentioned, some number of the highest scoring candidates are then provided as the aforementioned multi-word text completion suggestions.

In various implementations, weights for the various scoring elements of the language model may be learned via the optional retype process described in further detail in Section 2.2 of this document. In general, the retype process virtually retypes each document, character by character, and scores all the candidate phrases generated by the retrieval model. This retype process then adjusts the scoring parameters or weights of the language model so that the phrase that the user actually typed next obtains the highest score. Further, this retype process for training the weights can be performed on any desired corpus of preexisting documents, and may be the same as, or different from the documents used to train either or both the retrieval model and the language model.

Regardless of the types of retrieval models and language models applied by the Interactive Text Completion System, the resulting multi-word text completion suggestions are presented to the user via the aforementioned interactive user interface. However, for purposes of explanation, specific examples of retrieval models, language models, user interface examples and usage scenarios will be discussed herein. The Interactive Text Completion System is not intended to be limited to the use of any particular retrieval model or language model, or to the use of any particular user interface or usage scenario described herein.

1.1 System Overview:

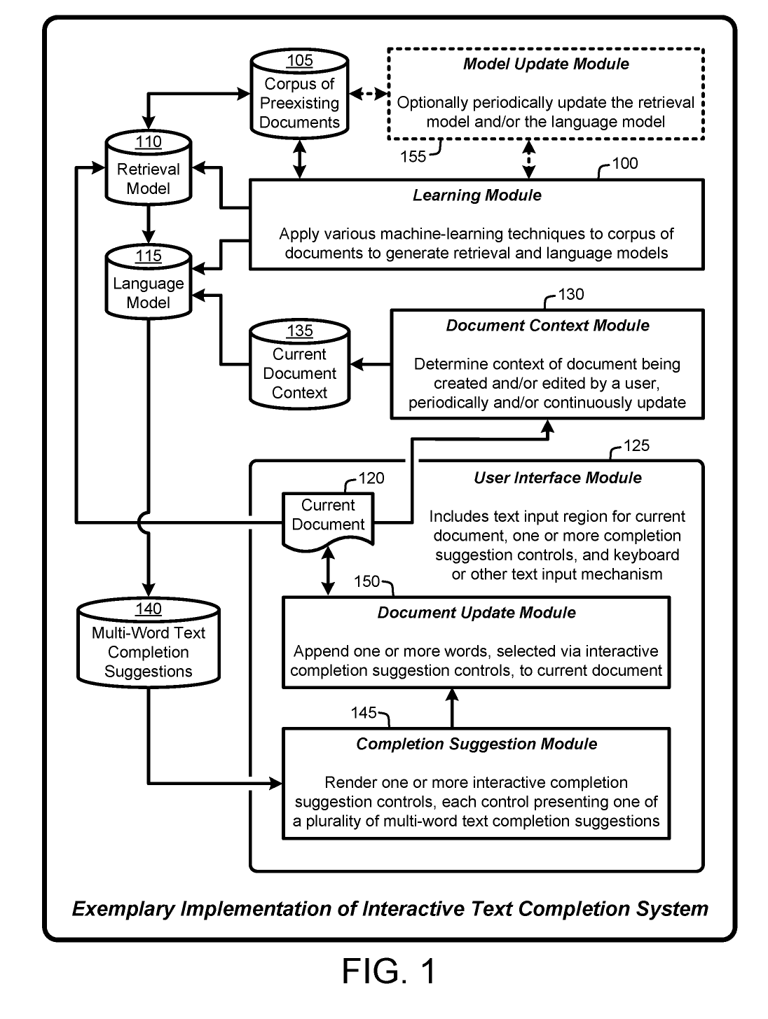

As mentioned above, the Interactive Text Completion System provides various techniques for presenting personalized context-based multi-word text completion suggestions that are updated in real-time as the user types and/or selects one or more words of the multi-word text completion suggestions. The processes summarized above are illustrated by the general system diagram of FIG. 1. In particular, the system diagram of FIG. 1 illustrates the interrelationships between program modules for implementing various implementations of the Interactive Text Completion System, as described herein. Furthermore, while the system diagram of FIG. 1 illustrates a high-level view of various implementations of the Interactive Text Completion System, FIG. 1 is not intended to provide an exhaustive or complete illustration of every possible implementation of the Interactive Text Completion System as described throughout this document.

In addition, any boxes and interconnections between boxes that may be represented by broken or dashed lines in FIG. 1 represent alternate implementations of the Interactive Text Completion System described herein, and any or all of these alternate implementations, as described below, may be used in combination with other alternate implementations that are described throughout this document.

As illustrated by FIG. 1, in various implementations, the processes enabled by the Interactive Text Completion System begin operation by executing a Learning Module 100 that applies various machine-learning techniques to one or more sets of source documents, collectively referred to herein as a corpus of preexisting documents 105 to generate both a retrieval model 110 and a language model 115.

In various implementations, the Interactive Text Completion System includes a User Interface Module 125. The User Interface Module 125 presents an interactive user interface that includes, but is not limited to, a text input region for a current document 120, one or more completion suggestion controls (e.g., see FIG. 2 through FIG. 4), and a virtual keyboard or other virtual and/or physical input mechanism (depending on the type of computing platform being used, e.g., phone, desktop, tablet, virtual or augmented reality based display, etc.) for entering text and interacting with the completion suggestion controls.

Then when the current document 120 is created and/or edited via the User Interface Module 125, a Document Context Module 130 determines a current document context 135 of that current document. In addition, the retrieval model 110 identifies and extracts multi-word candidate phrases from the corpus of preexisting documents 105 (or some content- or context-based subset of those preexisting documents) based on a current content (and optionally the current context 135) of the current document 120.

The multi-word candidate phrases extracted by the retrieval model 110 and the current document context 135 are both then provided to the language model 115. The language model 115 then scores the candidate phrases and outputs one or more of the highest scoring candidates as corresponding multi-word text completion suggestions 140. One or more of these multi-word completion suggestions 140 are then provided to a Completion Suggestion Module 145 of the User Interface Module 125. The Completion Suggestion Module 145 renders one or more interactive completion suggestion controls within the interactive user interface provided by the User Interface Module 120. Each of these interactive completion suggestion controls presents one of the multi-word text completion suggestions 140. A Document Update Module 150 then appends one or more words selected via any of the completion suggestion controls to the current document 120.

Further, in various implementations, a Model Update Module 155 optionally periodically updates (via the Learning Module 100) either or both the retrieval model 110 and the language model 110 as additional source documents become available, or whenever it is desired to train or retrain these models on a new or expanded corpus of preexisting documents.

2.0 Operational Details:

The above-described program modules and/or devices are employed for instantiating various implementations of the Interactive Text Completion System. As summarized above, the Interactive Text Completion System provides various techniques for presenting personalized context-based multi-word text completion suggestions that are updated in real-time as the user types and/or selects one or more words of the multi-word text completion suggestions. The following sections provide a detailed discussion of the operation of various implementations of the Interactive Text Completion System, and of exemplary methods and techniques for implementing the features and program modules described in Section 1 with respect to FIG. 1. In particular, the following sections provides examples and operational details of various implementations of the Interactive Text Completion System, including:

An operational overview of the Interactive Text Completion System;

Language model considerations;

An exemplary completion suggestion algorithm;

Training data preparation considerations; and

Exemplary User Interfaces.

2.1 Operational Overview:

As mentioned above, the Interactive Text Completion System provides various techniques for presenting personalized context-based multi-word text completion suggestions that are updated in real-time as the user (also referred to herein as the author) types and/or selects one or more words of the multi-word text completion suggestions. User selection of one or more words of any multi-word text completion suggestion is performed via a user interface that enables sequential selection of individual words or multi-word phrases or sentences of the multi-word text completion suggestion. In various implementations, the multi-word text completion suggestions are a combination of both predicted word completions (e.g., the remainder of a word, or a spelling corrected word, that a user has begun entering) and sequences of multiple suggested follow-on words.

2.2 Language Model Considerations:

As mentioned above, for purposes of explanation, specific examples of retrieval models and language models will be discussed herein. As such, it is understood that the Interactive Text Completion System is not intended to be limited to the use of any particular retrieval model (for finding candidate suggestions) or any particular language model (for scoring the candidate suggestions based on document context) in combination with the various user interface implementations described herein.

In various implementations, during construction of the retrieval model and language model, an evaluation is performed on completions of sentence prefixes from a test set of messages or other documents from the corpus. To evaluate acceptability of suggested completions, the learning algorithm for generating the retrieval model considers various metrics, including, but not limited to: (a) whether or not a suggested completion exactly matched an actual sentence ending in the corpus, and (b) the author's own assessment of whether or not they would have accepted such a completion as is, without editing. One motivation for such criterion is that accepting a suggestion and editing it may often require more work than simply entering the sentence in its original form.

As such, in various implementations, during the construction of the retrieval model, manual human review of completions of user's own documents were evaluated to determine which suggested completions were acceptable. Further, in various implementations, one or more fully automatic evaluations, each based on a large corpus of publicly available documents from a single author, were considered to determine which suggested completions were acceptable. The acceptability of such completions were then applied, in combination with automatically determined document context, to train the aforementioned language model. Further, in various implementations, scoring parameters or weights of the language model are trained or otherwise optimized via a “retype process” as described in further detail herein. In various implementations, past user behavior (e.g., kinds of suggestions they accept) and user traits (personality, type of work, etc.) may also be used as weights to increase or decrease the computed scores.

Consider a sequence of previously created documents, D¹, D², . . . , where each of the documents Dⁱ=(Mⁱ, s₁ⁱ, s₂ⁱ, . . . , sₙ_{ⁱ} ⁱ) consists of metadata Mⁱ ∈ [symbol] and nⁱ sentences. Sentence sⱼⁱ ∈ [symbol] * is a sequence wⱼ₁ⁱ, wⱼ₂ⁱ, . . . , wⱼₙ_{ⱼ}_{ⁱ}ⁱ of nⱼⁱ words w ∈ [symbol] . For purposes of discussion, i and j are omitted when clear from context. For word sequence x₁, x₂, . . . , xₙ, the term x[:i] is used to denote the prefix x₁, x₂, . . . , xᵢ₋₁ and x[i:]=xᵢ, xᵢ₊₁, . . . xₙ to denote the suffix. For purposes of explanation, the following discussion omits the use of punctuation and considers predictions at word boundaries. However, as mentioned above, the “words” of each multi-word text completion suggestion include various combinations of actual words, slang words, punctuation (e.g., spaces, commas, periods, exclamation points, etc.), symbols, emoji's, etc., such that the Interactive Text Completion System accounts for punctuation while offering a plurality of multi-word text completion suggestions (also referred to in the following paragraphs as simply a “completion) after each character. Before writing the kth word of the jth sentence of the ith document, the completion cⱼₖⁱ=A(wⱼⁱ[:k], χⱼₖⁱ) is the result of the algorithm A that is run with input the prefix wⱼⁱ[:k]=wⱼ₁ⁱ, . . . , wⱼ₍ₖ₋₁₎ⁱ and the current document context χⱼₖⁱ, defined as:

χⱼₖⁱ=(D[:i],Mⁱ,sⁱ[:j])

consisting of the previous documents, D[:i] (which as mentioned above includes both metadata and sentences of those prior documents), metadata, Mⁱ, of the current document being edited or created by the user, and preceding full or partial sentences, sⁱ[:j], of the current document being edited or created by the user. The user may choose to accept or reject the suggested completion cⱼₖⁱ. The algorithm may also choose to abstain from offering a completion by outputting the null completion ϵ if no suitable completion suggestion is found.

In various implementations, the Interactive Text Completion System optionally applies a “retype process” that is run over a corpus of sent messages (or other documents), word by word. Multi-word text completion suggestions are then generated by the retype process from chronologically earlier messages (or other documents). The multi-word text completion suggestions may then be evaluated for acceptability, either manually by the original author or automatically, with the acceptability of those suggestions then being used to adjust or otherwise train scoring parameters or weights of the language model. However, as mentioned, the use of this retype process is optional, and the language model may be trained without adjusting the scoring parameters or weights of that model based on the acceptability of suggestions generated by the retype process. In various implementations, the retype process of the Interactive Text Completion System focuses on completions of length at least M=6 or more words that are acceptable to the author. The threshold of six was chosen to roughly capture the observed usefulness of such a system and also to distinguish it from the more familiar problem of completing a single word or phrase. However, the length of M may be set to any desired value.

In the retype process, the Interactive Text Completion System offers a multi-word text completion suggestion if a computed score of that completion suggestion is above a confidence threshold. The author then decides whether to accept that completion suggestion (with that acceptance or non-acceptance being used to adjust scoring parameters or weights of the language model). Further, total length of these suggestions effects the adjustments to the scoring parameters or weights of the language model, with longer completions (e.g., a sequence of M=6 or more words) having a greater influence on weight adjustments because longer acceptable completions generally correspond to significantly reduced user workload in creating or editing the document.

Since any sentence in any message or document to retype could potentially be completed, the term “recall” is defined as a value that is relative to the total number of sentences. More specifically, the term “recall” is defined herein as the number of suggested completions divided by the number of sentences considered (e.g., recall=(# accepted completions)/(# sentences considered)). Further, the term “precision” is defined herein as the number of accepted completions divided by the number of suggested completions (e.g., (precision=# accepted completions)/(# suggested completions)). Once a suggestion is accepted in a sentence, the recall process does not count any other suggestions in that same sentence, to avoid giving multiple credit.

2.3 Exemplary Completion Suggestion Algorithm:

In various implementations, the aforementioned retrieval model generates suggested completions by finding, based on the current document context (and optionally current document content), verbatim text from the author's own prior email or other documents, essentially generating (or finding) completion suggestions that plagiarize the author's own prior writings. The user can then select some or all of that suggested text via the user interface for use in creating and/or editing new documents. Advantageously, the use of such verbatim text from the author's prior work increases the likelihood that the completion is grammatical, sensible, and in the author's own voice or grammatical style (e.g., a style and content typical of the user). However, suggestions may be generated from any other prior documents rather than limiting the search for suggestions to the user's own prior documents. The following paragraphs describe various elements of this process, including candidate search, vectorization, and scoring.

2.3.1 Searching for Candidates with a Retrieval Model:

A candidate location is defined herein as a message or other document in the corpus together with a position in its body. The Interactive Text Completion System considers offering the completion of the sentence found at that position, which is referred to herein as a candidate suffix. The term candidates may also be used in the following discussion when it is clear from context whether the discussion is referring to the suffix or location. However, in various implementations, the retrieval model maintains locations at all points in time since they are more efficient and contain additional information about the message (or other document).

The retrieval model first finds candidate locations that are preceded by text which perfectly agrees back with as many words as possible with what the user has just typed, e.g., to the end of the prefix being completed. In various implementations, the retrieval model uses a suffix array to identify these locations efficiently. In various implementations, the retrieval model looks for matches of the last k words of the prefix, finding the maximal k such that at least 5 suffixes remain (or any other desired number of remaining suffixes). If more than some adjustable maximum number of locations (e.g., 1,000 locations) remain after this process, the retrieval model takes that maximum number of locations from the most recent messages or other documents. In various implementations, assuming that the multi-word text completion suggestions have a length of M=6 words to finish a sentence, the retrieval model prunes any candidate suffixes with fewer than M words remaining in the sentence. Further, in various implementations, the retrieval model allows the prefix match to span backwards over sentence and paragraph boundaries, which helps make suggestions even before the user has typed a single character.

2.3.2 Vectorization:

Once a set of candidates has been identified by the retrieval model, the challenge is then to determine which suffix (e.g., which of the candidates) is most likely to complete the current sentence. To do this the language model uses several features to score those candidates, as described in the following paragraphs.

Contextual Local Density Score: In various implementations, the language model of the Interactive Text Completion System efficiently searches for one or more highest scoring phrases comprising any substring within one or more sets of preexisting source documents. If the model confidence (e.g., score determined by the language model) is sufficiently high for one or more candidate phrases (or complete sentences or longer) extracted by the retrieval model, the Interactive Text Completion System displays those phrases as multi-word text completion suggestions. In various implementations, the highest scoring phrases are based on a number of features including, but not limited to, a feature defined herein as a “contextual local density.”

In general, the contextual local density favors completions that use frequent words in the current document context such as “Thank [you so much for your interest in the position.]” over “Thank [you for the application you sent Tuesday morning.]” where the suggested text is italicized and displayed in brackets following the word “Thank” that has either been entered by the user or selected from a previously displayed multi-word text completion suggestion. In various implementations, the multi-word text completion suggestions are made by first pruning likely suggestions to a small set of candidates and then maximizing a matching score where the weights on the language model (also referred to as a “scoring function”) are trained by maximizing a heuristic performance criterion on the author's prior messages or other documents.

Among a set of candidates, some may be more generally useful than others and thus more likely to be appropriate for the message or other document currently being written. A clue that a suffix is generally useful is if many similar suffixes occur within its context throughout the corpus. In various implementations, the language model computes the Jaccard similarity between each candidate and all other candidates in the set. Further, the contextual local density score of a candidate is defined herein as the mean similarity with the top N (e.g., 10) most similar other candidates.

Unlike the remaining features described herein, contextual local density is a clustering-based score that depends on the other candidates. Advantageously, one property of contextual local density is that no hard decisions have to be made—it is a real value that can be computed for each candidate.

Prefix Match: For each candidate c, in various implementations, the language model computes a prefix match score, defined herein as log(1+k_{c}), where k_{c} is the number of trailing words in common between the prefixes of c and the current message or other document. This number of trailing words, k_{c}, may be larger than the initial candidate match k because there may be fewer than 5 suffixes (or any other desired number of suffixes) with the larger k_{c}. Similar to the aforementioned candidate search process, the language model allows the prefix match to span sentence and paragraph boundaries.

N-Gram Likelihood: When few words from the prefix match, some candidates may be ungrammatical or simply nonsensical. As such, in various implementations, this issue is addressed by an “N-gram likelihood score.” The N-gram likelihood score of a candidate is defined herein as the mean log likelihood of each word in the resulting sentence. Further, in various implementations, the language model uses probability estimates and smoothing weights computed via the use of a N-gram baseline model (see Section 2.4.1).

Subject Similarity: Often the subject of a message or other document is very informative for predicting the resulting text. In various implementations, the language model constructs TF-IDF-weighted word count vectors of the subjects of all messages or other documents. Further the subject similarity is defined herein as the cosine similarity of the subject vector of the current message or other document with the subject vector of the message or other document from which the candidate originated.

Quoted-Document Similarity: If the current message or document is a reply or a forward or is otherwise closely related, the content of the quoted material in that reply or forward could be informative (e.g., when replying to an email message, the original email message is often fully quoted in that reply). As with subject similarity, the quoted-document similarity is defined as the cosine similarity of the TF-IDF vectors of the quoted material within the current message or document with that of the candidate, or 0 if either message or document lacks any quoted material.

2.3.3 Scoring Candidates:

In various implementations, the language model forms a feature vector \vec{x} for each candidate location (with respect to the current sentence prefix and context) from the features listed above. The language model scores each candidate using a linear combination of the feature vectors \vec{w}·\vec{x}. The Interactive Text Completion System then outputs one or more of the highest scoring suggestion candidates if its score exceeds a threshold α. Otherwise it outputs a null suggestion ϵ.

Since it is not known which candidates would be accepted by a human, and to smooth the acceptance criterion so that partial progress can be noted during training, a real-valued heuristic score h is applied for a completion c with respect to true sentence completion c*, described below in Section 2.3.5. A large positive value for h indicates an acceptable completion while a large negative value reflects a poor completion.

In various implementations, the null completion ϵ is also a candidate, with heuristic score 0. Although this is not a requirement of the language model. The feature vector of ϵ is identically 0 except in a designated coordinate where it is 1 and all other candidates are 0. This enables the learning algorithm for generating the language model to learn when not to offer a suggestion, and it also serves the purpose of normalizing scores to rank confidences across examples.

2.3.4 Learning Feature Weights:

To find a weight vector \vec{w} that accurately scores candidates relative to each other, the learning algorithm for generating the language model identifies a set of opportunities in the training set in which an exact match is possible, finds the set of candidates and their vectors that the algorithm would consider at that point, and then applies a margin-based approach to find a weight vector that identifies the highest scoring candidate among the set.

An opportunity is defined herein as a location within the training set (e.g., the corpus of preexisting documents) where exactly M words remain in the sentence and those words also complete at least two other sentences in the training set. For example, in an actual email corpus of a particular author, this definition yielded 2,233 “opportunities.” The learning algorithm then randomly sampled some set number (e.g., 500) of those opportunities for training.

In various implementations, the learning algorithm follows a large-margin approach similar to that used in structured prediction techniques. For example, for the ith opportunity, let the vectors corresponding to the candidates be \vec{x}₁ⁱ,\vec{x}₂ⁱ, . . . , \vec{x}ₘ_{ᵢ}ⁱ. For the moment, suppose that the bᵢth candidate was a unique “best” candidate in the sense of maximizing its heuristic, for each opportunity. Then a noiseless max-margin optimization problem would be:

min∥\vec{w}∥² such that ∀i∀a≠bᵢ\vec{w}·(x_{b}_{ᵢ}ⁱ−xₐⁱ)≥1

where 1/∥\vec{w}∥ represents the margin between each best candidate and the rest.

To tolerate model imperfection and noise, this hard constraint is replaced with the hinge loss and regularized, yielding:

$${min}_{\vec{w}} λ {‖ \vec{w} ‖}^{2} + {\sum }_{i} {max}_{a \neq {b}_{i}} {( 1 - \vec{w} \cdot ( {x}_{{b}_{i}}^{i} - {x}_{a}^{i} ) )}_{+}$$

where (z)₊=max{z, 0} denotes the positive part of a real z. In general, a larger margin is used depending on the heuristic h. In particular, if the heuristic score of completion j on example i is hⱼⁱ then its margin is penalized based on the difference h_{b}_{ᵢ}ⁱ−hⱼⁱ instead of 1 for each example j, leading to:

$${min}_{\vec{w}} λ {‖ \vec{w} ‖}^{2} + {\sum }_{i} {max}_{a \neq {b}_{i}} {( {h}_{{b}_{i}}^{i} - {h}_{a}^{i} - \vec{w} \cdot ( {x}_{{b}_{i}}^{i} - {x}_{a}^{i} ) )}_{+}$$

The above is the optimization problem solved by considering the following. Since max is convex, this is a convex optimization problem which is readily minimized using gradient descent on bounded-size training sets. Since this process is operating in a low-dimensional space, the effect of regularization is minor and λ can be taken to be quite small. Finally, in the case where there are multiple candidates with maximal heuristic values, the most recent ones prior to the actual message or document being currently drafted are chosen.

2.3.5 Heuristic Acceptability Score:

In various implementations, the language model employs a heuristic score to indicate the quality of a suggested completion with respect to the true completion. This heuristic provides a more refined notion of quality than exact match, and is also meant to correlate with the likelihood that a human would accept a completion. As mentioned, the heuristic score of a null completion (no suggestion) is defined to be 0. As such, a negative heuristic score indicates a case where one would prefer no suggestion to making that suggestion. One example of a heuristic used for this purpose is defined in the following paragraphs.

Assume that the true suffix is w₁, w₂, . . . , wₙ and that the candidate suffix is u₁, u₂, . . . , uₘ. The language model first determines how many common words they share in common from the beginning, e.g., k=max{i|uᵢ=wᵢ}. Then the resulting heuristic value is defined to be:

h=−10+Σ_{i≤k}|wᵢ|,

where |w| denotes the number of characters in word w. The constant 10 represents a cost of roughly 10 characters for showing a suggestion in the first place. However, this constant may be set to any desired value. For example, if the true completion of a message providing directions was “Round the corner and take the first right” and the candidate was “Round the corner and turn right” the heuristic would be |Round|+|the|+|corner|+|and|−10=7. This heuristic does not reward the completion for the fact that the words ‘take’ and ‘turn’ both start with the same letter. Alternately, in various implementations, a classifier is trained to better approximate a human notion of acceptability.

2.4 Training Data Preparation Considerations:

In various implementations, training data (i.e., the corpus of existing documents) for learning the retrieval model and/or the language model was optionally preprocessed to remove duplicate messages, identify greetings and signatures, parse sentences, and tokenize document bodies into sentences. In various implementations, the tokenization process documents features, including, but not limited to, start-of-message, start-of-paragraph, start-of-sentence tokens, etc. In addition, this tokenization process splits words on spaces, slashes, and hyphens, and separates trailing punctuation such as periods, commas, exclamation points, etc., into separate tokens. Further, a record of each actual text string is maintained after each token in order to accurately reconstruct the original text.

In various implementations, for counting the number of words in a suggestion, the Interactive Text Completion System applies a simpler definition than the tokenization process, e.g., words are delimited by whitespace. In other words, for purpose of determining the length of the multi-word text completion suggestion, the algorithm does not provide credit for completing a period at the end of a sentence.

In various implementations, the corpus was divided into a training set for learning feature weights and a chronologically later test set for testing the language model using those learned weights. However, the entire corpus may be applied as a training set for learning the retrieval model and/or the language model.

2.4.1 N-Gram Baseline:

In various implementations, the Interactive Text Completion System applied an N-gram baseline language model to generate multi-word text completion suggestions from the corpus. The N-gram baseline language model estimates the probability of a word wᵢ given previous word sequnce by a mixture of N-gram models, 1≤n≤N, wᵢ₋₁, wᵢ₋₂, . . . , w₁ by

P(wᵢ|wᵢ₋₁, wᵢ₋₂, . . . , w₁)=λ₁P(wᵢ)+Σₙ₌₂^{N}λₙP(wᵢ|wᵢ₋₁, . . . , wᵢ₋ₙ₊₁)

where the conditional probability is estimated on the training corpus. This is a commonly used technique for overcoming the sparsity of high-order N-grams. In a tested implementation, the Interactive Text Completion System applied a 4-gram model and set the values of λ₁, λ₂, λ₃, and λ₄ to be 0.5, 0.3, 0.1, and 0.1, respectively. However, other values of λ₁, λ₂, λ₃, and λ₄ may be applied.

In the decoding phase, given a sentence segment w₁, w₂, . . . wₜ, the N-gram baseline language model applies a beam search Viterbi algorithm to find the most likely completion with length T−t

$${max}_{{w}_{t + 1} , … , {w}_{T}} P ( {w}_{t + 1} … {w}_{T} \vert {w}_{t} , {w}_{t - 1} , … , {w}_{1} ) = {max}_{{w}_{t + 1} , … , {w}_{T}} {\prod }_{i = t + 1}^{T} P ( {w}_{i} \vert {w}_{i - 1} , … , {w}_{1} ) .$$

In order to compare completions with different lengths, the log-likelihood of each predicted completion was normalized by its length and applied as a score for the comparison. As with the context-based approach described above, the length of the predicted string was restricted to be at least M=6 words. However, again, any desired predicted string length may be applied when predicting the multi-word text completion suggestions.

2.5 Exemplary User Interfaces:

Regardless of what type of retrieval model and language model is used by the Interactive Text Completion System, in various implementations, user selection of one or more words of any multi-word text completion suggestion is performed via a user interface that enables either sequential selection of individual words or selection of multi-word segments or sentences of the multi-word text completion suggestion. However, given the wide variability of user interfaces that may be implemented, the Interactive Text Completion System is not intended to be limited to the exact details of the exemplary user interface examples described in the following paragraphs.

For example, in various implementations user selection from the multi-word text completion suggestions is performed by successive selections of one or more selectable words of one or more of a plurality of multi-word text completion suggestions being concurrently displayed to the user. More specifically, in various implementations, selection of any word within any multi-word text completion suggestion initiates a selection of the selected word and each preceding selectable word of that multi-word text completion suggestion. When making selections from any of the multi-word text completion suggestions presented in the exemplary user interfaces described herein, a variety of selection mechanisms may be applied in any desired combination.

Further, in various implementations, a variety of different available user interface actions (performed via any desired input mechanism) may be presented with respect to any multi-word text completion suggestion. Examples of such actions include, but are not limited to, selection of a single word of a multi-word text completion suggestion, selection of a single phrase of a multi-word text completion suggestion, selection of an entire sentence from a multi-word text completion suggestion, selection of an entire multi-word text completion suggestion, open or view the document from which a multi-word text completion suggestion was extracted, etc. Further, a single gesture, such as tapping or otherwise selecting a word of a multi-word text completion suggestion may result in the insertion of a sequence of multiple words into the document. Further, in various implementations, some words of a particular multi-word text completion suggestion may be automatically deleted by the Interactive Text Completion System and replaced with content placeholders (e.g., fill-in-the-blank type UI controls) for content such as names, dates, places, objects, costs, tasks, travel information or reservations, etc., along with facilities to select and fill in or otherwise complete those content placeholders.

For example, as illustrated by FIG. 2, a user interface is instantiated on a display 200 of a computing device 205. In various implementations, the display 200 is a touchscreen. Interaction with or selection of the various user interface elements rendered on the display 200 may be performed by the user via pointing devices or the like, touch-based inputs, speech-based inputs, or any other natural user interface (NUI) based input mechanism. However, for purposes of explanation with respect to the following example, it will be assumed that the display 200 is a touchscreen device and that interaction with the user interface rendered on the display is performed via touch- or tap-based gestures.

As illustrated by FIG. 2, in various implementations, the user interface of the Interactive Text Completion System includes a text input region 210 in which text is entered and/or edited by the user. For example, the text input region 210 of FIG. 2 illustrates user entered and/or selected text of “My address”. In addition, in various implementations, text, including whole words, individual characters, punctuation and symbols, may be entered into the text input region 210 and/or edited via a virtual keyboard 215 rendered on the display 200.

Further, the exemplary user interface illustrated in FIG. 2 includes multiple completion suggestion controls (220, 225 and 230). In various implementations, additional completion suggestion controls can be provided via the user interface by performing swipe-type operations or the like to scroll left or right (or up or down) through one or more additional completion suggestion controls that may not be currently visible on the display 200. Each of the completion suggestion controls (e.g., 220, 225 and 230) includes a different multi-word text completion suggestion.

In the example of FIG. 2, each completion suggestion control (220, 225 and 230) shows a multi-word text completion suggestion (which may include a partial word completion if the user has already begun entering characters of a word). In this example, each completion suggestion control (220, 225 and 230) shows both selectable text (optionally highlighted in this example) and non-selectable text preceding that selectable text. In various implementations, this optional highlighting includes any combination of larger text, different font, bolded or italicized, different color, blinking word, etc.).

As mentioned, because the text strings of each multi-word text completion suggestion are verbatim extractions, in various implementations, these multi-word text completion suggestions may include non-selectable text that precedes the selectable text so as to show a larger portion of the original document from which that multi-word text completion suggestion was extracted. As such, in the example of FIG. 2, completion suggestion control 220 shows non selectable text (235) of “My mailing address” and bolded selectable text (250) of “is 456 Third Street, Anytown, Mass.” The non-selectable text 235 is also optionally highlighted in some way (e.g., lighter text as illustrated, text of a different color, etc.) to indicate that the text is non-selectable. In this case, the combination of the selectable text 250 and non-selectable text 235 represent a single verbatim extraction from a particular source document. By comparing the selectable text 250 and the non-selectable text 235 to the text of “My address” in text input region 210, it can be seen that the selectable text of completion suggestion control 220 follows the word “address” such that the selectable portion of the multi-word text completion suggestion matches, at least in part, the last one or more words of text in the text input region 210. However, such matching is not a requirement of the Interactive Text Completion System.

Similarly, completion suggestion control 225 shows non selectable text 240 of “If I remember correctly, you asked me to make sure the address” and selectable text 265 of “on the form you printed out was correct (456 Third Street), and it was.” In this example, only a portion 255 of the selectable text 265 that is scored by the language model as being most a likely completion is highlighted (i.e., “on the form”). However, the user is free to select any or all of the selectable text 265 shown in completion suggestion control 225.

Similarly, completion suggestion control 230 shows non selectable text 245 of “If you need another pair of hands to help you carry the equipment, let us know your address” and selectable text 270 of “and we'll send someone over.” In this example, only a portion 260 of the selectable text that is scored by the language model as being most a likely completion is highlighted (i.e., “and”). However, the user is free to select any or all of the selectable text shown in completion suggestion control 230.

Within any of the completion suggestion controls (220, 225, 230), selection of any selectable word of the corresponding multi-word text completion suggestion initiates a selection of the selected word and each preceding selectable word of the corresponding multi-word text completion suggestion. For example, as discussed above, completion suggestion control 225 shows selectable text 265 of “on the form you printed out was correct (456 Third Street), and it was.” As such, selection of the word “correct” via this completion suggestion control 225 will cause the text in text input region to be updated to read “My address on the form you printed out was correct”.

Further, in response to this exemplary selection of the word “correct” the content, and possibly the context, of the current user document will change. As such, based on the changed content and/or context, the Interactive Text Completion System may immediately present new or updated multi-word text completion suggestions in each of the completion suggestion controls (220, 225, 230). In various implementations, text in the control (e.g., 225) being selected does not change (other than making the selected words (e.g., “on the form you printed out was correct”) non-selectable within the control. Similarly, at any time that the user enters text via the keyboard 215 (or other input mechanism) rather than selecting one of the completion suggestion controls (e.g., 220, 225 or 230), some or all of those completion suggestion controls may change in response to user this user text entry based the combination of the content of the document and the current document context, as discussed above.

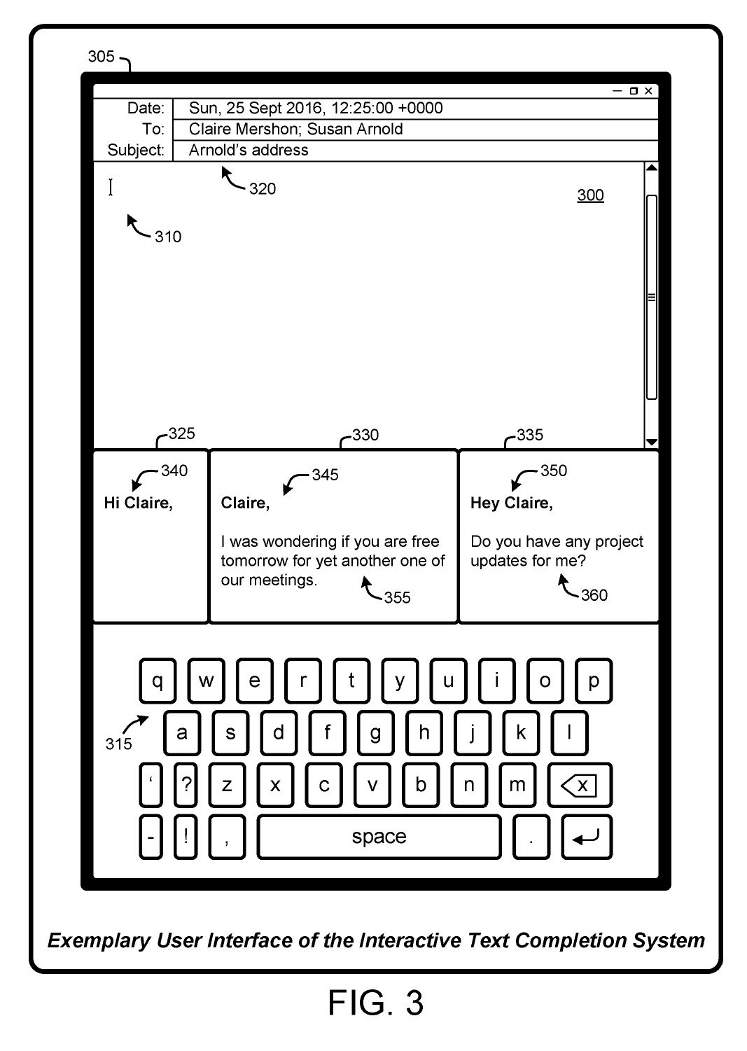

FIG. 3 provides an example similar to that of FIG. 2. As with FIG. 2, FIG. 3 illustrates a user interface instantiated on a display 300 of a computing device 305 along with a virtual keyboard 315. However, in contrast to FIG. 2, in the example of FIG. 3, a new document has been created without any text having yet been entered into text input region 310. Although the text input region 310 does not include any content, this new document does include a date, recipients and a subject line (315), some or all of which may provide context for this new document.

As such, in the example of FIG. 3, each of the multiple completion suggestion controls (325, 330 and 340) includes a different multi-word text completion suggestion that is based on the context derived from any or all of the date, recipients and a subject line (315) rather than the content of the document. For example, completion suggestion control 325 shows bolded selectable text (340) of a multi-word text completion suggestion of “Hi Claire,”.

Similarly, completion suggestion control 330 shows bolded selectable text 345 of “Claire,” and additional selectable text 355 of the multi-word text completion suggestion of “I was wondering if you are free tomorrow for yet another one or our meetings.” In this example, only a portion 345 of the selectable text (combination of 345 and 355) that is scored by the language model as being most a likely completion is highlighted (i.e., “Claire,”). However, the user is free to select any or all of the selectable text (345 and 355) of the multi-word text completion suggestion shown in completion suggestion control 330.

Similarly, completion suggestion control 335 shows bolded selectable text 350 of “Hey Claire,” and additional selectable text 360 of the multi-word text completion suggestion of “Do you have any project updates for me.” In this example, only a portion 350 of the selectable text (combination of 350 and 360) that is scored by the language model as being most a likely completion is highlighted (i.e., “Hey Claire,”). However, the user is free to select any or all of the selectable text (350 and 360) of the multi-word text completion suggestion shown in completion suggestion control 330.

As with FIG. 2, within any of the completion suggestion controls (325, 330, 335), selection of any selectable word of the corresponding multi-word text completion suggestion initiates a selection of the selected word and each preceding selectable word of the corresponding multi-word text completion suggestion. For example, as discussed above, completion suggestion control 330 shows selectable text (345 and 355) of “Claire, I was wondering if you are free tomorrow for yet another one or our meetings.” As such, selection of the word “tomorrow” via this completion suggestion control 330 will cause the text in text input region to be updated to read “Claire, I was wondering if you are free tomorrow”.

Further, as with the example of FIG. 2, in response to this exemplary selection of the word “tomorrow” from completion suggestion control 330 of FIG. 3, the content, and possibly the context, of the current user document will change. As such, based on the changed content and/or context, the Interactive Text Completion System may immediately present new or updated multi-word text completion suggestions in each of the completion suggestion controls (325, 330, 335).

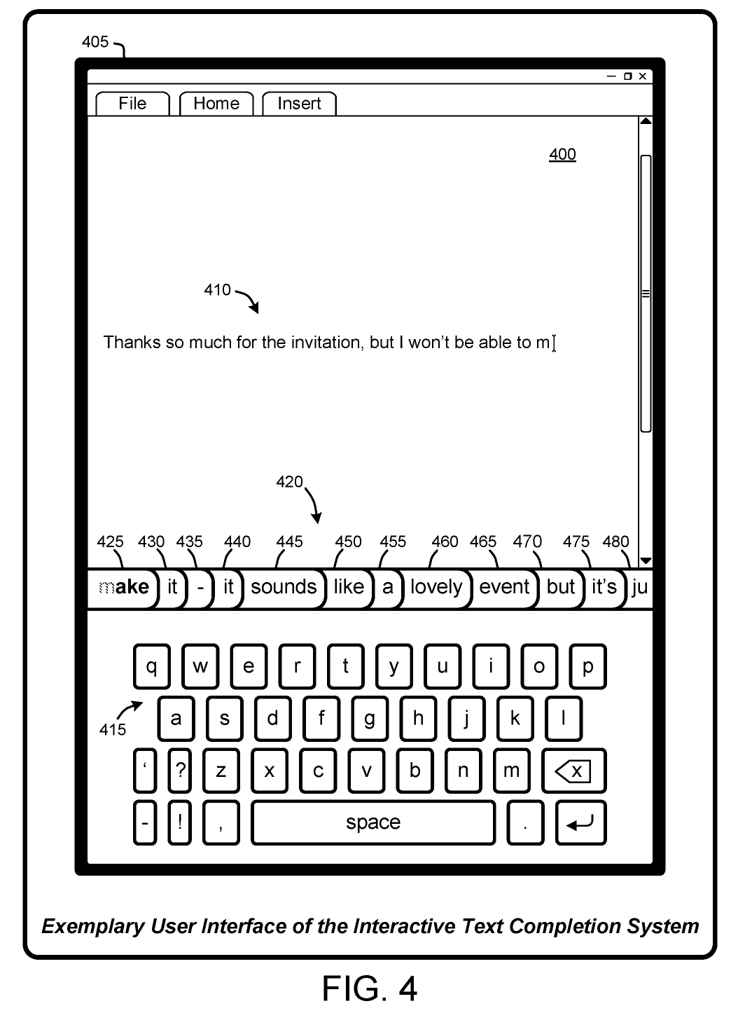

FIG. 4 illustrates another example of a user interface enabled by the Interactive Text Completion System. For example, as illustrated by FIG. 4, in various implementations user selection from the multi-word text completion suggestion is performed via a touch or tap gesture or the like to perform ongoing selections of words and phrases with each tap. In this exemplary user interface, each user selection corresponds to one or more words (and possibly including a partial word completion if the user has already begun entering characters of a word) of the multi-word text completion suggestion concurrently displayed to the user.

For example, as illustrated by FIG. 4, a user interface is instantiated on a display 400 of a computing device 405. In various implementations, the display 400 is a touchscreen. Interaction with or selection of the various user interface elements rendered on the display 400 may be performed by the user via pointing devices or the like, touch-based inputs, speech-based inputs, or any other natural user interface (NUI) based input mechanism. However, for purposes of explanation with respect to the following example, it will be assumed that the display 400 is a touchscreen device and that interaction with the user interface rendered on the display is performed via touch- or tap-based gestures.

As illustrated by FIG. 4, in various implementations, the user interface of the Interactive Text Completion System includes a text input region 410 in which text is entered and/or edited by the user. For example, the text input region 410 of FIG. 4 illustrates user entered and/or selected text of “Thanks so much for the invitation, but I won't be able to m”. In this example, the “m” at the end of this phrase represents the first letter of a word being entered by the user via a virtual keyboard 415 or other input mechanism. In addition, in various implementations, text, including whole words, individual characters, punctuation and symbols, may be entered into the text input region 410 and/or edited via the virtual keyboard 415.

Further, the exemplary user interface illustrated in FIG. 4 includes a single completion suggestion control 420 comprising a sequence of user selectable words (425 through 480) of a multi-word text completion suggestion. In addition, because the length of multi-word text completion suggestion (e.g., number and length of words) may exceed the available screen real estate, the multi-word text completion suggestion in control 420 is user scrollable (e.g., swipe-type gesture or the like) to view and/or select any word of that multi-word text completion suggestion.

Further, in various implementations, one or more additional completion suggestion controls (not shown in FIG. 4) can be provided via the user interface in combination with completion suggestion control 420. For example, one or more of these additional completion suggestion controls (with a different multi-word text completion suggestion) may be rendered adjacent to completion suggestion control 420 (e.g., as a parallel control above control 420). This additional completion suggestion control would include a different multi-word text completion suggestion with another sequence of user selectable words similar to elements 425 through 480.

As illustrated, the completion suggestion control 420 shows a partial word completion 425 of the word “make” based on the user entry of the “m” at the end of the current phrase in the text input region 410. In this example, because the user has already begun entering characters of a word beginning with the letter “m”, the first word of the multi-word text completion suggestion provided by control 420 shows that the next selectable word is “make” 425. In this example, because the “m” has already been entered, the next selectable word “make” 425 is partially highlighted (e.g., any combination of larger text, different font, bolded or italicized, different color, blinking word, etc.) following the “m” to show that the word is a completion of the letter “m”. If the user has not entered one or more letters of a partial word, then the first selectable word in completion suggestion control 420 will simply be a full word. In this case, this full word may be optionally highlighted to show that it is the next word that will be appended to the text in text input region 410 if it, or any subsequent word in the completion suggestion control, is selected by the user.

As mentioned above, in this example, the completion suggestion control 420 includes a sequence of user selectable words (425 through 480) of the multi-word text completion suggestion. User selection of any of the sequence of user selectable words (425 through 480) causes selection of both the selected word and all preceding words of the multi-word text completion suggestion presented via the completion suggestion control 420. As such, selection of any of these words (425 through 480) selects that word and all preceding words, and appends those selected words to the end of the existing text in the text input region 410. Concurrently, the selected words are removed from the completion suggestion control 420, and the remaining words of the multi-word text completion suggestion (and any subsequent words not currently visible due to space constraints) will scroll to the left (assuming a left-to-right reading order) so as to update the words in that completion suggestion control.

For example, if the user selects the word “like” 450 of the completion suggestion control 420, the text in the text input region 410 will be automatically updated to read “Thanks so much for the invitation, but I won't be able to make it—it sounds like”. Concurrently, the words of the completion suggestion control 420 of FIG. 4 will be updated to remove the selected words that were appended to the text in the text input region 410 and to replace or expand the multi-word text completion suggestion 420 based on the changed content (and possibly changed context) of the document.

Further, at any time that the user does not want to select a particular word of the multi-word text completion suggestion illustrated in completion suggestion control 420, the user can simply enter text via the keyboard 415 (or other input mechanism). Whenever the user enters text other than by selecting a word from the completion suggestion control 420, the text in the completion suggestion control may be updated to reflect a new multi-word text completion suggestion based on the combination of the content of the document and the current document context, as discussed above.

In a hybrid user interface, the completion suggestion controls of both FIG. 2 and FIG. 4, may be combined into a single user interface. For example, this hybrid user interface may include one or more of the completion suggestion controls (220 225 and 230) from FIG. 2 positioned adjacent to the completion suggestion control 420 from FIG. 4.

3.0 Operational Summary:

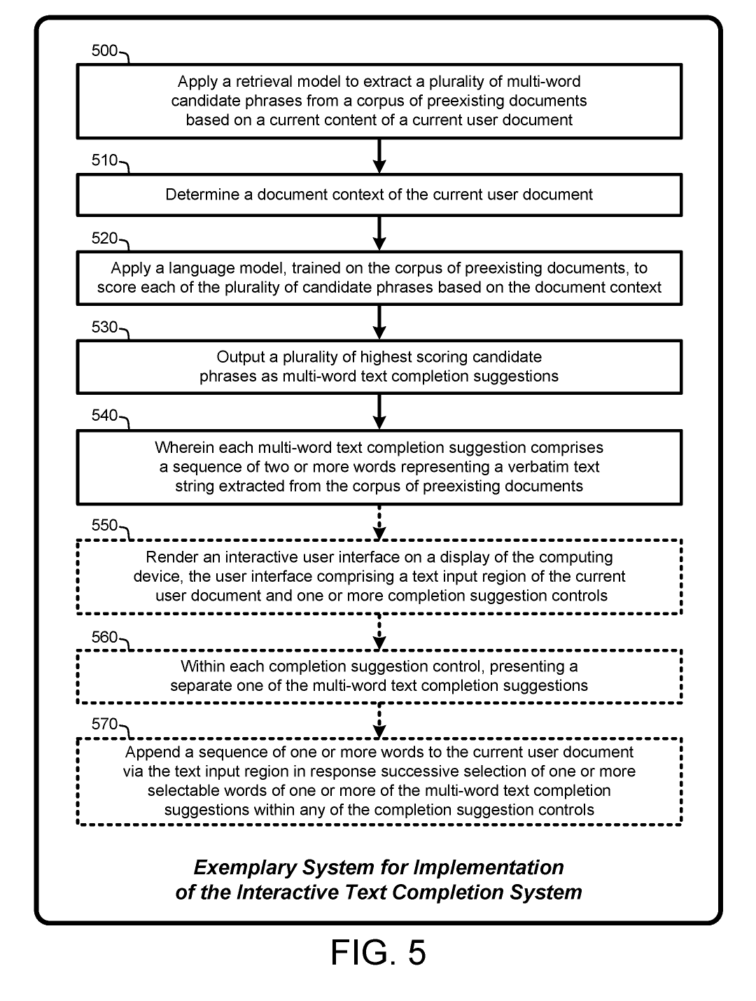

The processes described above with respect to FIG. 1 through FIG. 4, and in further view of the detailed description provided above in Sections 1 and 2, are illustrated by the general operational flow diagrams of FIG. 5 through FIG. 7. In particular, FIG. 5 through FIG. 7 provide exemplary operational flow diagrams that summarizes the operation of some of the various implementations of the Interactive Text Completion System. FIG. 5 through FIG. 7 are not intended to provide an exhaustive representation of all of the various implementations of the Interactive Text Completion System described herein, and the implementations represented in these figures are provided only for purposes of explanation.

Further, any boxes and interconnections between boxes that may be represented by broken or dashed lines in FIG. 5 through FIG. 7 represent optional or alternate implementations of the Interactive Text Completion System described herein, and that any or all of these optional or alternate implementations, as described below, may be used in combination with other alternate implementations that are described throughout this document.

In general, as illustrated by FIG. 5, in various implementations, the Interactive Text Completion System begins operation by applying 500 a retrieval model to extract a plurality of multi-word candidate phrases from a corpus of preexisting documents based on a current content of a current user document. In addition, Interactive Text Completion System determines 510 a document context of the current user document. In various implementations, the Interactive Text Completion System then applies 520 a language model, trained on the corpus of preexisting documents, to score each of the plurality of candidate phrases based on the document context. The Interactive Text Completion System then outputs 530 a plurality of highest scoring candidate phrases as multi-word text completion suggestions. In various implementations, each of the multi-word text completion suggestions comprises 540 a sequence of two or more words representing a verbatim text string extracted from the corpus of preexisting documents.

Further, as illustrated by FIG. 5, in various implementations, given the multi-word text completion suggestions, the Interactive Text Completion System renders 550 an interactive user interface on a display of the computing device, the user interface comprising a text input region of the current user document and one or more completion suggestion controls. In various implementations, within each completion suggestion control, the Interactive Text Completion System presents 560 a separate one of the multi-word text completion suggestions. The Interactive Text Completion System then appends 570 a sequence of one or more words to the current user document via the text input region in response successive selection of one or more selectable words of one or more of the multi-word text completion suggestions within any of the completion suggestion controls.

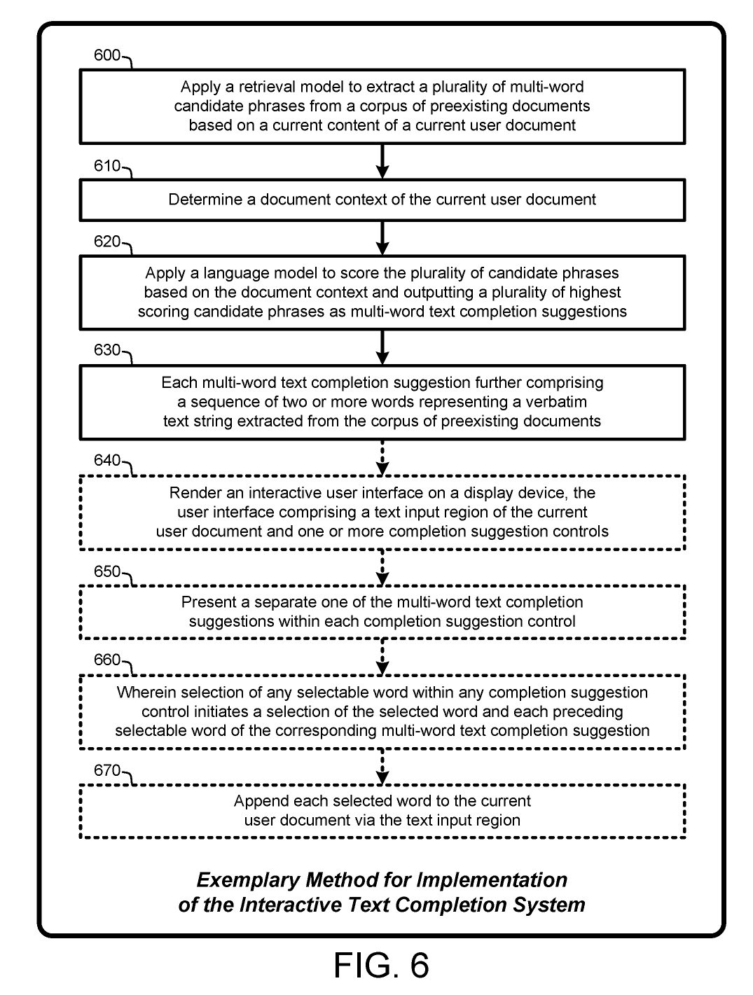

Similarly, as illustrated by FIG. 6, in various implementations, the Interactive Text Completion System begins operation by applying 600 a retrieval model to extract a plurality of multi-word candidate phrases from a corpus of preexisting documents based on a current content of a current user document. Next, the Interactive Text Completion System determines 610 a document context of the current user document. Given the candidates and the context, the Interactive Text Completion System then applies 620 a language model to score the plurality of candidate phrases based on the document context and then output a plurality of highest scoring candidate phrases as multi-word text completion suggestions. In various implementations, each multi-word text completion suggestion further comprises 630 a sequence of two or more words representing a verbatim text string extracted from the corpus of preexisting documents.

Further, as illustrated by FIG. 6, in various implementations, the Interactive Text Completion System renders 640 an interactive user interface on a display device. This user interface may comprise at least a text input region of the current user document and one or more completion suggestion controls. In various implementations, the Interactive Text Completion System then presents 650 a separate one of the multi-word text completion suggestions within each completion suggestion control. Further, selection 660 of any selectable word within any of the completion suggestion controls initiates a selection of the selected word and each preceding selectable word of the corresponding multi-word text completion suggestion. In various implementations, the Interactive Text Completion System then appends 670 each selected word to the current user document via the text input region.

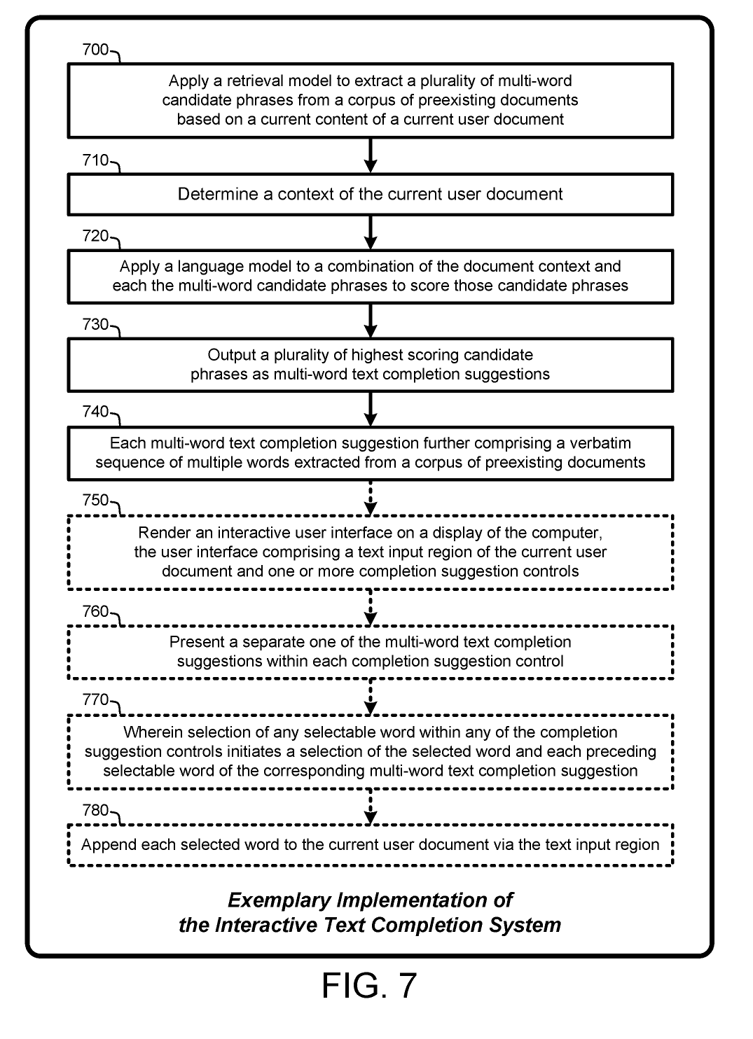

Similarly, as illustrated by FIG. 7, in various implementations, the Interactive Text Completion System begins operation by applying 700 a retrieval model to extract a plurality of multi-word candidate phrases from a corpus of preexisting documents based on a current content of a current user document. In addition, the Interactive Text Completion System determines 710 a context of the current user document. Given the candidate phrases and context, the Interactive Text Completion System then applies 720 a language model to a combination of the document context and the multi-word candidate phrases to score those candidate phrases. Further, the Interactive Text Completion System outputs 730 a plurality of highest scoring candidate phrases as multi-word text completion suggestions. Each of these multi-word text completion suggestions further comprises 740 a verbatim sequence of multiple words extracted from a corpus of preexisting documents.

Further, in various implementations, the Interactive Text Completion System renders 750 an interactive user interface on a display of the computer, the user interface comprising a text input region of the current user document and one or more completion suggestion controls. In various implementations, the Interactive Text Completion System then presents 760 a separate one of the multi-word text completion suggestions within each completion suggestion control. Further, selection 770 of any selectable word within any of the completion suggestion controls initiates a selection of the selected word and each preceding selectable word of the corresponding multi-word text completion suggestion. The Interactive Text Completion System then appends 780 each selected word to the current user document via the text input region.

4.0 Exemplary Implementations:

The following paragraphs summarize various examples of implementations of the Interactive Text Completion System that may be claimed in the present document. The implementations summarized below are not intended to limit the subject matter that may be claimed in view of the detailed description of the Interactive Text Completion System. Further, any or all of the implementations summarized below may be claimed in any desired combination with some or all of the implementations described throughout the detailed description and any implementations illustrated in one or more of the figures, and any other implementations and examples described below. The following implementations and examples are intended to be understood in view of the detailed description and figures described throughout this document.

In various implementations, an Interactive Text Completion System is implemented by means, processes or techniques for presenting personalized context-based multi-word text completion suggestions that are updated in real-time as the user types and/or selects one or more words of the multi-word text completion suggestions. As such, the Interactive Text Completion System enhances and improves user experience by reducing user workload and time spent in generating a wide variety of document types.

As a first example, in various implementations, an Interactive Text Completion System is implemented by a general purpose computing device via means, processes or techniques that begin operation by applying a retrieval model to extract a plurality of multi-word candidate phrases from a corpus of preexisting documents based on a current content of a current user document. In various implementations, the Interactive Text Completion System the determines a document context of the current user document. Next, in various implementations, the Interactive Text Completion System applies a language model (also referred to as a scoring function), trained on the corpus of preexisting documents, to score each of the plurality of candidate phrases based on the document context. The Interactive Text Completion System then outputs a plurality of highest scoring candidate phrases as multi-word text completion suggestions. Further, in various implementations, each of these multi-word text completion suggestions comprises a sequence of two or more words representing a verbatim text string extracted from the corpus of preexisting documents.

As a second example, in various implementations, the first example is further modified via means, processes or techniques further comprising rendering an interactive user interface on a display of the computing device, the user interface comprising a text input region of the current user document and one or more completion suggestion controls. In addition, within each completion suggestion control, the Interactive Text Completion System presents a separate one of the multi-word text completion suggestions. Further, in various implementations, the Interactive Text Completion System appends a sequence of one or more words to the current user document via the text input region in response selection of one or more selectable words of one or more of the multi-word text completion suggestions within any of the completion suggestion controls.

As a third example, in various implementations, any of the first example and the second example are further modified via means, processes or techniques wherein each multi-word text completion suggestion further comprises a combination of both a predicted word completion and a sequence of one or more suggested follow-on words subsequent to the predicted word completion.

As a fourth example, in various implementations, any of the first example, the second, and the third example are further modified via means, processes or techniques wherein the corpus of preexisting documents comprises multiple prior documents created by the user such that the suggestions generated are consistent with a style and content typical of the user.

As a fifth example, in various implementations, any of the first example and the second example are further modified via means, processes or techniques further comprising applying the retrieval model to extract an updated plurality of multi-word candidate phrases from the corpus of preexisting documents whenever any words are appended to the current user document. In addition, in various implementations the document context is updated whenever any words are appended to the current user document. Further, in various implementations, the Interactive Text Completion System applies the language model to score each of the updated plurality of candidate phrases based on the updated document context. Finally, in various implementations, the Interactive Text Completion System outputs a plurality of highest scoring updated candidate phrases as updated multi-word text completion suggestions.

As a sixth example, in various implementations, any of the first example, the second example, the third example, the fourth example and the fifth example are further modified via means, processes or techniques further comprising determining the document context as a combined function of sentences and metadata of documents in the corpus, preceding sentences of the current document, and metadata of the current document.

As a seventh example, in various implementations, any of the second example and the fifth example are further modified via means, processes or techniques further comprising presenting all of the words of one or more of the multi-word text completion suggestions as individually selectable words. In addition, selection of any of those individually selectable words causes selection of a multi-word phrase comprising the selected word and all of the preceding words of the multi-word text completion suggestion. Finally, in various implementations, the Interactive Text Completion System appends the multi-word phrase to the current user document via the text input region.

As an eighth example, in various implementations, any of the second example, the fifth example and the seventh example are further modified via means, processes or techniques wherein a next selectable word within one or more of the completion suggestion controls represents a partial word completion of a partially entered word of the current user document in the text input region.

As a ninth example, in various implementations, any of the second example, the fifth example, the seventh example and the eighth example are further modified via means, processes or techniques wherein the user interface further comprises a virtual keyboard for entering one or more characters.

As a tenth example, in various implementations, the Interactive Text Completion System is implemented via means, processes or techniques that begin operation by applying a retrieval model to extract a plurality of multi-word candidate phrases from a corpus of preexisting documents based on a current content of a current user document. In addition, the Interactive Text Completion System determines a document context of the current user document. Further, in various implementations, the Interactive Text Completion System applies a language model to score the plurality of candidate phrases based on the document context and outputting a plurality of highest scoring candidate phrases as multi-word text completion suggestions. Each of these multi-word text completion suggestions further comprising a sequence of two or more words representing a verbatim text string extracted from the corpus of preexisting documents.

As an eleventh example, in various implementations, the first example is further modified via means, processes or techniques further comprising rendering an interactive user interface on a display device, the user interface comprising a text input region of the current user document and one or more completion suggestion controls. In addition, the Interactive Text Completion System presents a separate one of the multi-word text completion suggestions within each completion suggestion control. Further, in various implementations, selection of any selectable word within any of the completion suggestion controls initiates a selection of the selected word and each preceding selectable word of the corresponding multi-word text completion suggestion. Finally, in various implementations, the Interactive Text Completion System appends each selected word to the current user document via the text input region.

As a twelfth example, in various implementations, any of the tenth example and the eleventh example are further modified via means, processes or techniques further comprising personalizing the language model to emulate a style of the user by applying a learning algorithm to a corpus of the user's preexisting documents to train the language model.

As a thirteenth example, in various implementations, the eleventh example is further modified via means, processes or techniques further comprising applying the retrieval model to extract an updated plurality of multi-word candidate phrases from the corpus of preexisting documents whenever any word is appended to the current user document. In addition, in various implementations, the Interactive Text Completion System updates the document context whenever any word is appended to the current user document. Further, the Interactive Text Completion System applies the language model to score each of the updated plurality of candidate phrases based on the updated document context. Finally, in various implementations, the Interactive Text Completion System outputs a plurality of highest scoring updated candidate phrases as updated multi-word text completion suggestions.

As a fourteenth example, in various implementations, any of the eleventh example and the thirteenth example are further modified via means, processes or techniques further comprising highlighting one or more selectable words within one or more of the completion suggestion controls.

As a fifteenth example, in various implementations, any of the eleventh example, the thirteenth example and the fourteenth example are further modified via means, processes or techniques wherein a next selectable word within one or more of the completion suggestion controls represents a word completion of a partially entered word of the current user document in the text input region.

As a sixteenth example, in various implementations, any of the eleventh example, the thirteenth example, the fourteenth example and the fifteenth example are further modified via means, processes or techniques further comprising determining the document context as a combined function of sentences and metadata of documents in the corpus, preceding sentences of the current user document, and metadata of the current user document.

As a seventeenth example, in various implementations, the Interactive Text Completion System is implemented via means, processes or techniques that begin operation by applying a retrieval model to extract a plurality of multi-word candidate phrases from a corpus of preexisting documents based on a current content of a current user document. In addition, in various implementations, the Interactive Text Completion System determines a context of the current user document. Next, the Interactive Text Completion System applies a language model to a combination of the document context and the multi-word candidate phrases to score those candidate phrases. In various implementations, the Interactive Text Completion System the outputs a plurality of highest scoring candidate phrases as multi-word text completion suggestions. Further, each multi-word text completion suggestion further comprises a verbatim sequence of multiple words extracted from a corpus of preexisting documents.

As an eighteenth example, in various implementations, the seventeenth example is further modified via means, processes or techniques further comprising rendering an interactive user interface on a display of the computer, the user interface comprising a text input region of the current user document and one or more completion suggestion controls. In addition, the Interactive Text Completion System presents a separate one of the multi-word text completion suggestions within each completion suggestion control. Further, selection of any selectable word within any of the completion suggestion controls initiates a selection of the selected word and each preceding selectable word of the corresponding multi-word text completion suggestion. Finally, in various implementations, the Interactive Text Completion System appends each selected word to the current user document via the text input region.

As a nineteenth example, in various implementations, any of the seventeenth example and the eighteenth example are further modified via means, processes or techniques further comprising applying the retrieval model to extract an updated plurality of multi-word candidate phrases from the corpus of preexisting documents whenever any word is appended to the current user document. In addition, in various implementations, the Interactive Text Completion System updates the document context whenever any word is appended to the current user document. Further, in various implementations, the Interactive Text Completion System applies the language model to score each of the updated plurality of candidate phrases based on the updated document context. Finally, in various implementations, the Interactive Text Completion System outputs a plurality of highest scoring updated candidate phrases as updated multi-word text completion suggestions.

As a twentieth example, in various implementations, any of the seventeenth example, the eighteenth example and the nineteenth example are further modified via means, processes or techniques further comprising personalizing the language model to emulate a grammatical style of the user by applying a learning algorithm to a corpus of the user's preexisting documents to train the language model.

5.0 Exemplary Operating Environments:

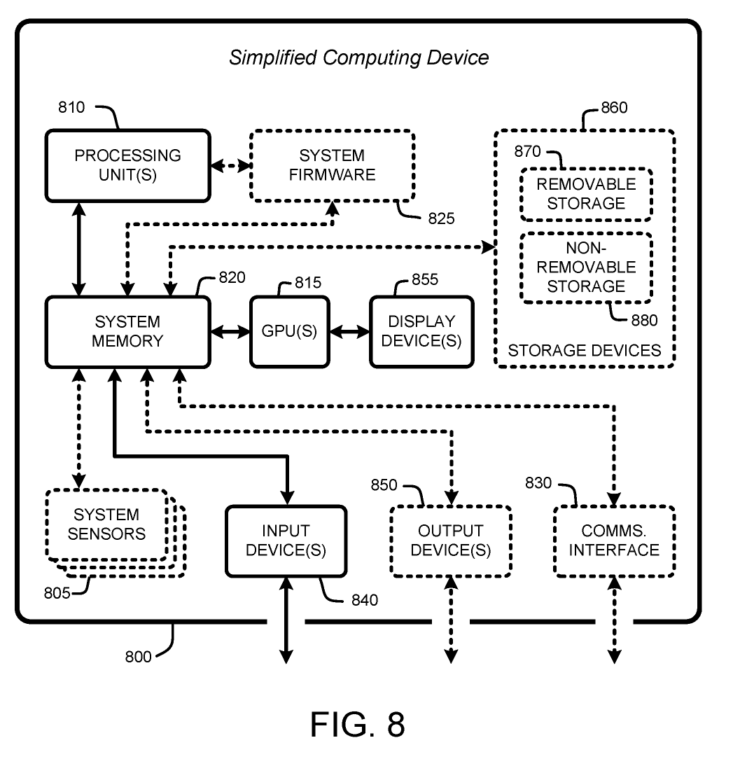

The Interactive Text Completion System implementations described herein are operational within numerous types of general purpose or special purpose computing system environments or configurations. FIG. 8 illustrates a simplified example of a general-purpose computer system on which various implementations and elements of the Interactive Text Completion System, as described herein, may be implemented. Any boxes that are represented by broken or dashed lines in the simplified computing device 800 shown in FIG. 8 represent alternate implementations of the simplified computing device. As described below, any or all of these alternate implementations may be used in combination with other alternate implementations that are described throughout this document.

The simplified computing device 800 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the Interactive Text Completion System implementations described herein, the device should have a sufficient computational capability and system memory to enable basic computational operations. In particular, the computational capability of the simplified computing device 800 shown in FIG. 8 is generally illustrated by one or more processing unit(s) 810, and may also include one or more graphics processing units (GPUs) 815, either or both in communication with system memory 820. The processing unit(s) 810 of the simplified computing device 800 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 800 may also include other components, such as, for example, a communications interface 830. The simplified computing device 800 may also include one or more conventional computer input devices 840 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 800 and with any other component or feature of the Interactive Text Completion System, including input, output, control, feedback, and response to one or more users or other devices or systems associated with the Interactive Text Completion System, are enabled by a variety of Natural User Interface (NUI) scenarios. The NUI techniques and scenarios enabled by the Interactive Text Completion System include, but are not limited to, interface technologies that allow one or more users user to interact with the Interactive Text Completion System in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 840 or system sensors 805. Such NUI implementations are also enabled by the use of various techniques including, but not limited to, information derived from system sensors 805 or other input devices 840 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices.

Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the Interactive Text Completion System.

However, the aforementioned exemplary NUI scenarios may be further augmented by combining the use of artificial constraints or additional signals with any combination of NUI inputs. Such artificial constraints or additional signals may be imposed or generated by input devices 840 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the Interactive Text Completion System.

The simplified computing device 800 may also include other optional components such as one or more conventional computer output devices 850 (e.g., display device(s) 855, audio output devices, video output devices, devices for transmitting wired or wireless data transmissions, and the like). Typical communications interfaces 830, input devices 840, output devices 850, and storage devices 860 for general-purpose computers are well known to those skilled in the art, and will not be described in detail herein.

The simplified computing device 800 shown in FIG. 8 may also include a variety of computer-readable media. Computer-readable media can be any available media that can be accessed by the computing device 800 via storage devices 860, and include both volatile and nonvolatile media that is either removable 870 and/or non-removable 880, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. The terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various Interactive Text Completion System implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 825, hardware, or any combination thereof to control a computer to implement the disclosed subject matter. The term “article of manufacture” as used herein is intended to encompass a computer program accessible from any computer-readable device, or media.

The Interactive Text Completion System implementations described herein may be further described in the general context of computer-executable instructions, such as program modules, being executed by a computing device. Generally, program modules include routines, programs, objects, components, data structures, and the like, that perform particular tasks or implement particular abstract data types. The Interactive Text Completion System implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

6.0 Other Implementations:

The foregoing description of the Interactive Text Completion System has been presented for the purposes of illustration and description. It is not intended to be exhaustive or to limit the claimed subject matter to the precise form disclosed. Many modifications and variations are possible in light of the above teaching. Further, any or all of the aforementioned alternate implementations may be used in any combination desired to form additional hybrid implementations of the Interactive Text Completion System. It is intended that the scope of the Interactive Text Completion System be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the Interactive Text Completion System described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known to enable such interactions.

What is claimed is:

1. A system, comprising:
a general purpose computing device; and
a computer program comprising program modules executable by the computing device, wherein the computing device is directed by the program modules of the computer program to:
applying a retrieval model to extract a plurality of multi-word candidate phrases from a corpus of preexisting documents based on a current content of a current user document;
determine a document context of the current user document;
apply a scoring function, trained on the corpus of preexisting documents, to score each of the plurality of candidate phrases based on the document context;
output a plurality of highest scoring candidate phrases as multi-word text completion suggestions; and
wherein each multi-word text completion suggestion comprises a sequence of two or more words representing a verbatim text string extracted from the corpus of preexisting documents.

2. The system of claim 1, further comprising program modules that further direct the computing device to:
render an interactive user interface on a display of the computing device, the user interface comprising a text input region of the current user document and one or more completion suggestion controls;
within each completion suggestion control, present a separate one of the multi-word text completion suggestions; and
append a sequence of one or more words to the current user document via the text input region in response selection of one or more selectable words of one or more of the multi-word text completion suggestions within any of the completion suggestion controls.

3. The system of claim 1, each multi-word text completion suggestion comprising a combination of both a predicted word completion and a sequence of one or more suggested follow-on words subsequent to the predicted word completion.

4. The system of claim 1, wherein the corpus of preexisting documents comprises multiple prior documents created by the user such that the suggestions generated are consistent with a style and content typical of the user.

5. The system of claim 2, further comprising:
applying the retrieval model to extract an updated plurality of multi-word candidate phrases from the corpus of preexisting documents whenever any words are appended to the current user document;
updating the document context whenever any words are appended to the current user document;
applying the scoring function to score each of the updated plurality of candidate phrases based on the updated document context; and
outputting a plurality of highest scoring updated candidate phrases as updated multi-word text completion suggestions.

6. The system of claim 1 wherein the document context is determined as a combined function of sentences and metadata of documents in the corpus, preceding sentences of the current document, and metadata of the current document.

7. The system of claim 2 further comprising:
presenting all of the words of one or more of the multi-word text completion suggestions as individually selectable words;
wherein selection of any of those individually selectable words causes selection of a multi-word phrase comprising the selected word and all of the preceding words of the multi-word text completion suggestion; and
appending the multi-word phrase to the current user document via the text input region.

8. The system of claim 2 wherein a next selectable word within one or more of the completion suggestion controls represents a partial word completion of a partially entered word of the current user document in the text input region.

9. The system of claim 2, wherein the user interface further comprises a virtual keyboard for entering one or more characters.

10. A method for generating completion suggestions, comprising:
applying a retrieval model to extract a plurality of multi-word candidate phrases from a corpus of preexisting documents based on a current content of a current user document;
determining a document context of the current user document;
applying a language model to score the plurality of candidate phrases based on the document context and outputting a plurality of highest scoring candidate phrases as multi-word text completion suggestions; and
each multi-word text completion suggestion further comprising a sequence of two or more words representing a verbatim text string extracted from the corpus of preexisting documents.

11. The method of claim 10 further comprising:
rendering an interactive user interface on a display device, the user interface comprising a text input region of the current user document and one or more completion suggestion controls;
presenting a separate one of the multi-word text completion suggestions within each completion suggestion control;
wherein selection of any selectable word within any of the completion suggestion controls initiates a selection of the selected word and each preceding selectable word of the corresponding multi-word text completion suggestion; and
appending each selected word to the current user document via the text input region.

12. The method of claim 10 further comprising personalizing the language model to emulate a style of the user by applying a learning algorithm to a corpus of the user's preexisting documents to train the language model.

13. The method of claim 11, further comprising:
applying the retrieval model to extract an updated plurality of multi-word candidate phrases from the corpus of preexisting documents whenever any word is appended to the current user document;
updating the document context whenever any word is appended to the current user document;
applying the language model to score each of the updated plurality of candidate phrases based on the updated document context; and
outputting a plurality of highest scoring updated candidate phrases as updated multi-word text completion suggestions.

14. The method of claim 11 further comprising highlighting one or more selectable words within one or more of the completion suggestion controls.

15. The method of claim 11 wherein a next selectable word within one or more of the completion suggestion controls represents a word completion of a partially entered word of the current user document in the text input region.

16. The method of claim 11 wherein the document context is determined as a combined function of sentences and metadata of documents in the corpus, preceding sentences of the current user document, and metadata of the current user document.

17. A computer-implemented process comprising using a computer to perform process actions for:
applying a retrieval model to extract a plurality of multi-word candidate phrases from a corpus of preexisting documents based on a current content of a current user document;
determining a context of the current user document;
applying a language model to a combination of the document context and the multi-word candidate phrases to score those candidate phrases;
outputting a plurality of highest scoring candidate phrases as multi-word text completion suggestions; and
wherein each multi-word text completion suggestion further comprises a verbatim sequence of multiple words extracted from a corpus of preexisting documents.

18. The computer-implemented process of claim 17, further comprising:
rendering an interactive user interface on a display of the computer, the user interface comprising a text input region of the current user document and one or more completion suggestion controls;
presenting a separate one of the multi-word text completion suggestions within each completion suggestion control;
wherein selection of any selectable word within any of the completion suggestion controls initiates a selection of the selected word and each preceding selectable word of the corresponding multi-word text completion suggestion; and
appending each selected word to the current user document via the text input region.

19. The computer-implemented process of claim 17 further comprising process actions for:
applying the retrieval model to extract an updated plurality of multi-word candidate phrases from the corpus of preexisting documents whenever any word is appended to the current user document;
updating the document context whenever any word is appended to the current user document;
applying the language model to score each of the updated plurality of candidate phrases based on the updated document context; and
outputting a plurality of highest scoring updated candidate phrases as updated multi-word text completion suggestions.

20. The computer-implemented process of claim 17 further comprising process actions for personalizing the language model to emulate a grammatical style of the user by applying a learning algorithm to a corpus of the user's preexisting documents to train the language model.
